(19) United States
(12) Patent Application Publication
(10) Pub. No.: US 2008/0283166 A1
(43) Pub. Date: Nov. 20, 2008

(54) Method for manufacturing pneumatic tire

(75) Inventors: Toshiyuki Mafune, Kobe-shi (JP); Masayuki Sakamoto, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 12/076,535

(22) Filed: Mar. 19, 2008

(30) Foreign Application Priority Data
May 18, 2007 (JP) 2007-133195

(51) Int. Cl. B60C 9/14

(52) U.S. Cl. 152/209.1; 156/126

(57) ABSTRACT

A method for manufacturing a pneumatic tire with tread grooves comprises: building a green tire, and vulcanizing the green tire in a mold, wherein the building of the green tire includes making a tread rubber by overlap-winding a raw rubber tape, and the mold is provided with protrusions for molding the tread grooves on the tread rubber. During vulcanizing the green tire in the mold, one of the protrusions is positioned radially outside an end of the raw rubber tape so that the end is relatively pressed radially inwards of the tire by the protrusion.

The present invention relates to a method for manufacturing a pneumatic tire, more particularly to a tread rubber made up of numerous windings of a raw rubber tape capable of preventing molding defects and improving the tire uniformity.

Recently, a number of proposals to make various rubber components, e.g. tread rubber, sidewall rubber and the like of a pneumatic tire by overlap-winding a narrow unvulcanized rubber tape have been made, for example as disclosed in U.S. Pat. No. 7,093,629.

In order to improve the production efficiency of such a rubber component, the use of a relatively thick rubber tape is preferred because, if the rubber tape is very thin, it is necessary to wind the tape a very large number of times, and it will take a long time.

If the rubber tape is thick, however, the step formed at the end of the rubber tape becomes larger accordingly. Thus, the tire uniformity (e.g. RFV, RRO) is liable to deteriorate. Further, when such a relatively large step is formed on the outer surface of the raw rubber component such as raw tread rubber, there is a tendency that the step is remained on the molded outer surface of the vulcanized rubber component as if a scratch or cut exists. Furthermore, when such a relatively large step is formed on the inner surface of the raw rubber component, there is a tendency that in the vicinity of the step, air is remained between the rubber component and the underlying layer such as tread reinforcing belt. Even if the volume of the air is small, there is possibility of causing so called bareness of rubber, dent in the tire outer surface and the like.

It is therefore, an object of the present invention to provide a method for manufacturing a pneumatic tire, by which the deterioration of the tire uniformity and the above-mentioned mold defectiveness can be effectively prevented even if the rubber tape is relatively thick and accordingly the step formed at the end of the rubber tape is relatively large.

According to the present invention, a method for manufacturing a pneumatic tire with tread grooves comprises: building a green tire, wherein the building of the green tire includes making a tread rubber by overlap-winding a raw rubber tape; and vulcanizing the green tire in a mold, wherein the mold is provided with protrusions for molding the tread grooves on the tread rubber, and the method is characterized in that, during vulcanizing the green tire in the mold, one of the protrusions is placed radially outside an end of the raw rubber tape.

Therefore, during vulcanizing the tire, the end of the rubber strip is pressed down by the protrusion. The amount of pressing down is far larger in the portion where the protrusion exists than in the remaining portion where no protrusion exists. Accordingly, the step formed at the end of the rubber tape wound is reduced or the surface is leveled, and as a result, the deterioration of the tire uniformity and the mold defectiveness can be prevented.

Embodiments of the present invention will now be described in detail in conjunction with accompanying drawings, in which:

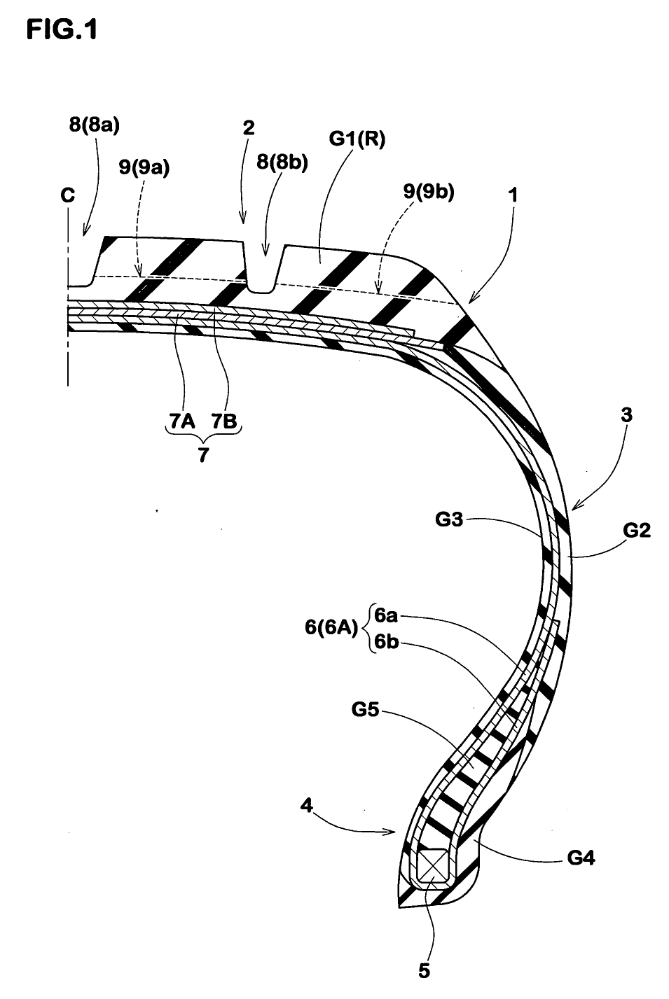

FIG. 1 is a cross sectional view of a pneumatic tire according to the present invention;

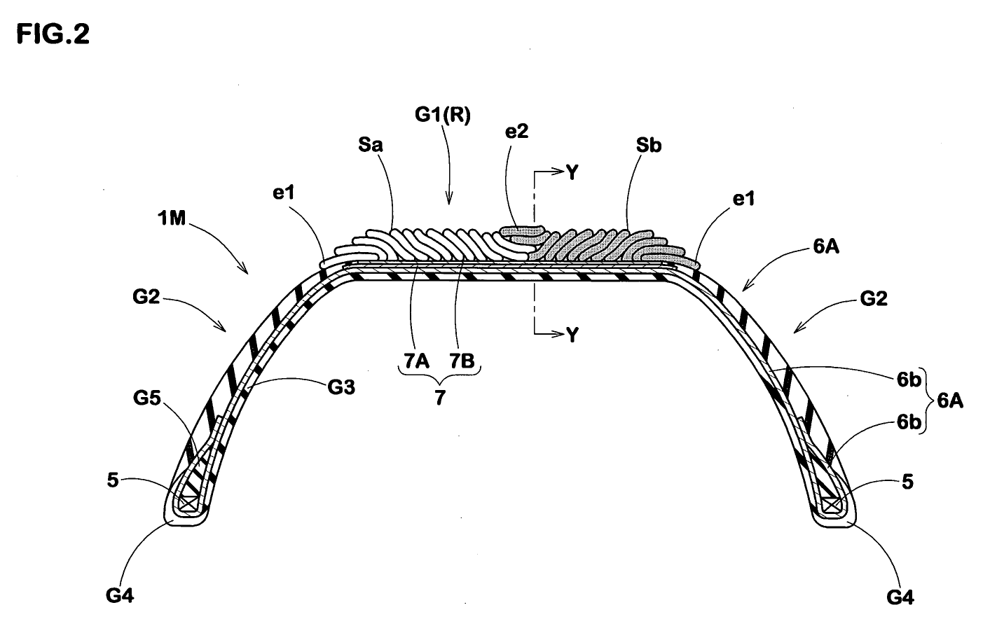

FIG. 2 is a cross sectional view of the green tire;

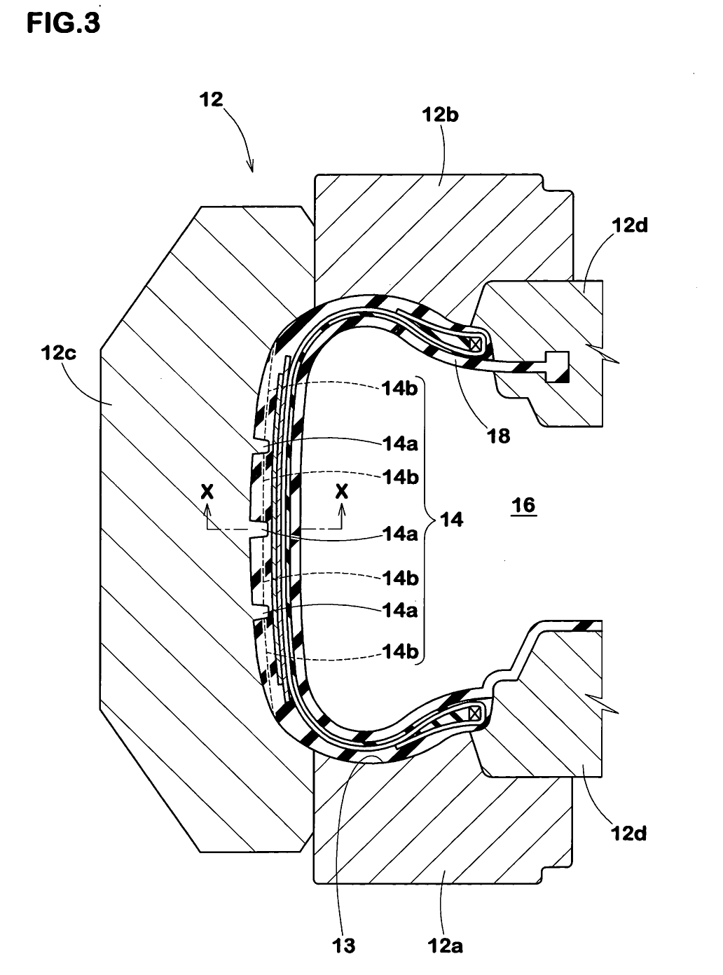

FIG. 3 is a cross sectional view of a tire mold in which the green tire is placed;

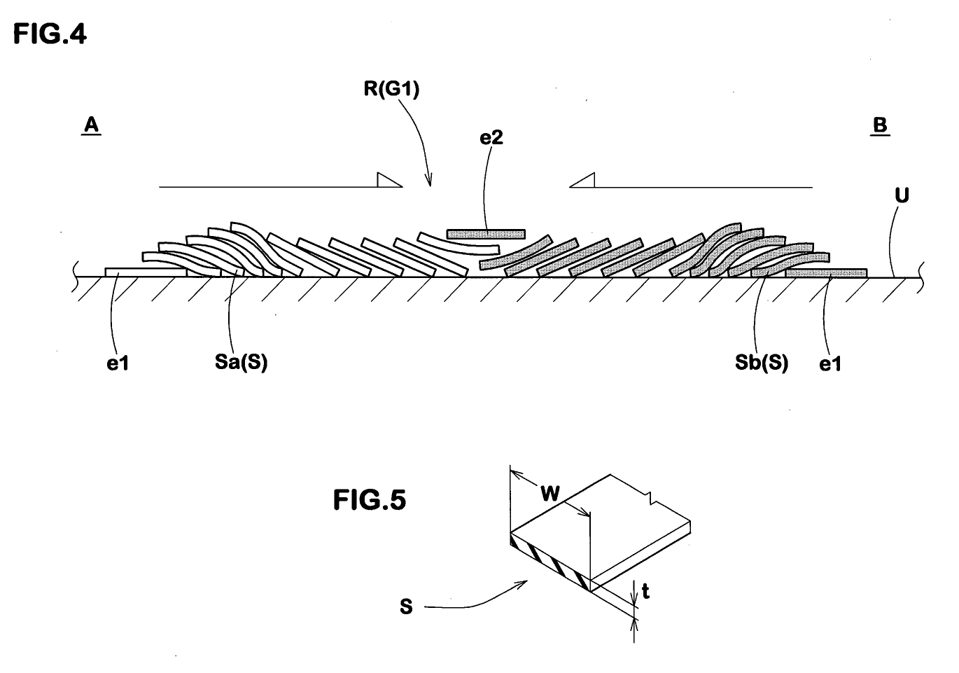

FIG. 4 is a schematic cross sectional view of a raw tread rubber made up of windings of raw rubber tapes;

FIG. 5 is a perspective view of the rubber tape;

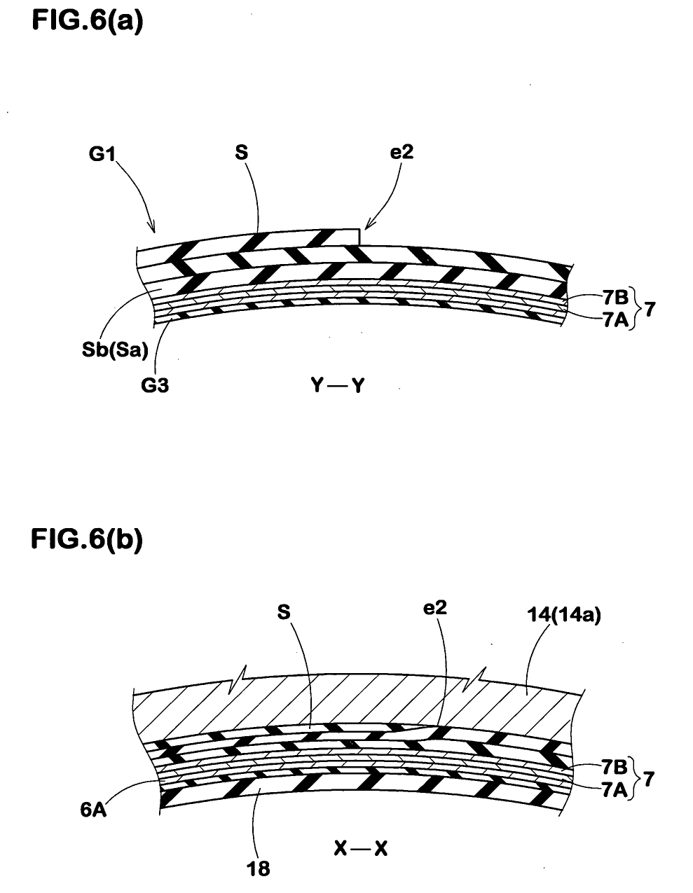

FIGS. 6(a) and 6(b) are cross sectional views of the same wind-ending end of the rubber tape before and after the wind-ending end is pressed by a protrusion of the tire mold;

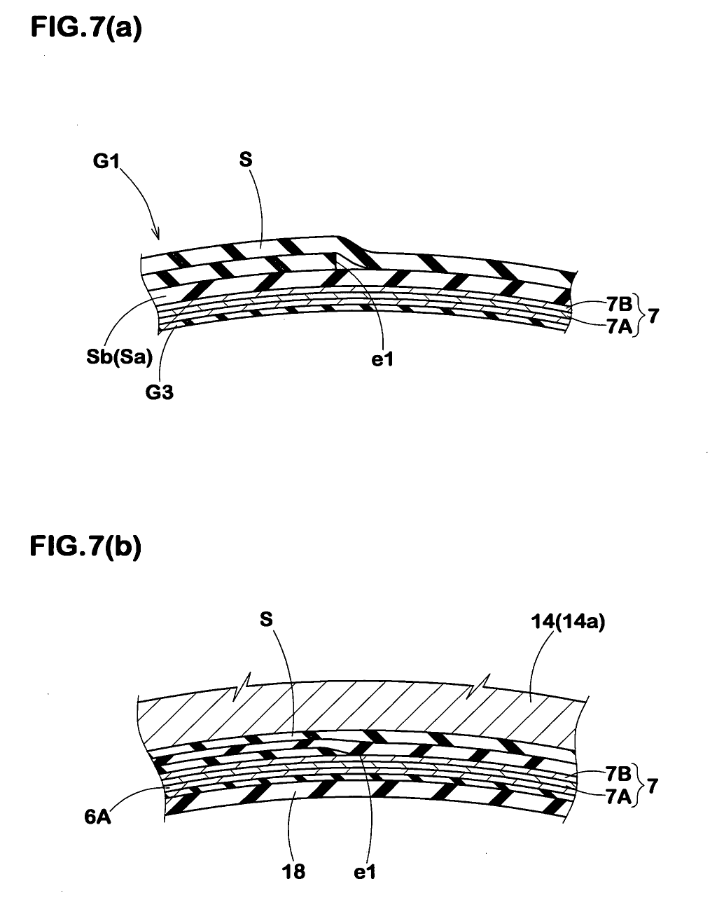

FIGS. 7(a) and 7(b) are cross sectional views of the same wind-starting end of the rubber tape before and after the wind-ending end is pressed by a protrusion of the tire mold;

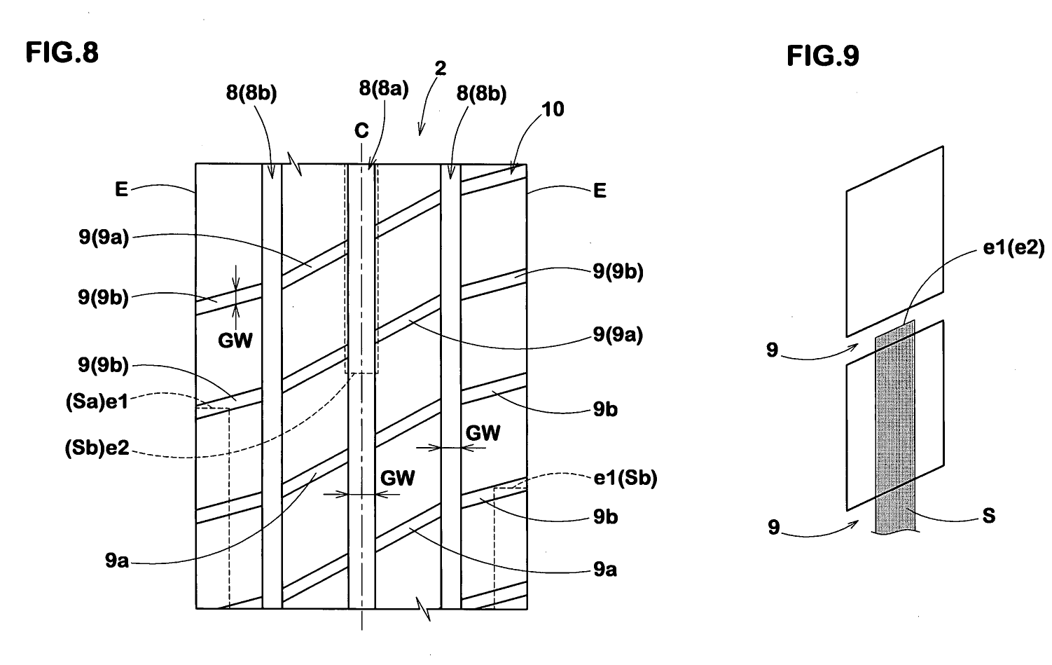

FIG. 8 is a plan view of the tread portion of the tire showing an example of the tread pattern; and

FIG. 9 is a diagram showing an end of the rubber tape wound.

In the drawings, pneumatic tire 1 according to the present invention comprises: a tread portion 2; a pair of axially spaced bead portions 4 each with a bead core 5 therein; a pair of sidewall portions 3 extending between the tread edges and the bead portions 4; a toroidal carcass 6 extending between the bead portions 4 through the tread portion 2 and sidewall portions 3; a belt 7 disposed radially outside the carcass 6 in the tread portion 2; and various rubber components G as shown in FIG. 1.

The carcass 6 is composed of at least one ply 6A of cords arranged radially at an angle in the range of from 70 to 90 degrees with respect to the tire equator C, extending between the bead portions 4 through the tread portion 2 and sidewall portions 3 and turned up around the bead core 5 in each bead portion 4 from the axially inside to the axially outside of the tire to form a pair of turnup portions 6b and a main portion 6a therebetween.

The belt includes a breaker 7 and optionally a band. The breaker 7 comprises: at least two cross plies 7A and 7B of high modulus cords such as steel laid at an angle of from 10 to 35 degrees with respect to the tire equator C.

The rubber components G include: a tread rubber G1 disposed on the radially outside of the belt in the tread portion to define the tread surface; a sidewall rubber G2 disposed axially outside the carcass 6 in each of the sidewall portions 3 to defined the outer surface of the sidewall portion; an air-impermeable innerliner rubber G3 disposed along the inside of the carcass 6; an abrasion-resistant clinch rubber G4 disposed in each of the bead portions 4 along the axially outer surface and bottom surface of the bead portion so as to contact with the wheel rim when the tire is mounted thereon; and a hard bead apex rubber G5 disposed in each of the bead portions 4 so as to extend radially outwardly from the bead core 5.

In this embodiment, the above-mentioned rubber components are included, but further components can be included. Here, the rubber component means not only a component made of a pure rubber but also a component made of a rubber reinforced by short fibers, cords or the like embedded therein.

The tread portion 2 is provided with tread grooves 10 defining a tread pattern. The tread grooves 10 include circumferential grooves 8 and axial grooves 9.

For example, the circumferential grooves 8 may include a central circumferential groove 8a along the tire equator C, and an axially outer circumferential groove 8b on each side of the tire equator C.

The axial grooves 9 may include central axial grooves 9a extending between the central circumferential groove 8a and outer circumferential grooves 8b, and outer axial grooves 9b extending between the outer circumferential grooves 8b and the tread edges E.

In any case, by the tread grooves 10, the tread portion 2 is provided with a tread pattern which is for example a block pattern made up of tread blocks only. But, aside from block patterns, various tread patterns, e.g. rib pattern, rug pattern, rib-rug pattern and the like can be provided.

In the following example, the circumferential grooves 8 and axial grooves 9 are illustrated as being straight for the sake of convenience, but it is of course possible to employ various configurations such as zigzag, wave, curved line and the like. Thus, the present invention is not limited to a specific tread pattern or specific groove configurations.

The tread grooves 10 are molded on the tread rubber G1 during vulcanizing the tire.

In order to manufacture the pneumatic tire 1, a green tire 1M is first built.

By the use of a tire building drum (not shown), the tire components: the tread rubber G1, sidewall rubber G2, innerliner rubber G3, bead rubber G4, carcass ply 6A, bead cores 5, belt 7, etc. are assembled into the green tire 1M in a toroidal shape as shown in FIG. 2.

Then, the green tire 1M is put in a mold 12 and vulcanized by applying heat and pressure. For that purpose, an inflatable bladder 18 is disposed inside the green tire 1M put in the mold 12 as shown in FIG. 3. The bladder 18 is inflated with a high-pressure high-temperature fluid to press the outer surface of the green tire 1M onto the molding surface 13 of the mold 12 and to heat the tire. At the same time, the mold is heated. Therefore, the tire is vulcanized.

According to the present invention, the tread rubber G1 is made up of multiple windings R of at least one raw rubber tape S as shown in FIGS. 4 and 5. Aside from the tread rubber G1, various rubber components G, e.g. the sidewall rubber G2, innerliner rubber G3, bead rubber G4, and the like can be made up of multiple windings of at least one raw rubber tape.

During the process of building the green tire, the tread rubber G1 is formed by overlap-winding the raw rubber tape(s) S around a round body U. Here, the round body u may be a drum having a specifically profiled or circular cylindrical surface, or a part finished green tire itself, namely the above-mentioned belt or an overlay on the belt. In view of the productive efficiency and the reduction in intermediate stock, it is preferred that the rubber tape S is wound directly on the belt or similar.

The raw rubber tape S is produced during the process of building the green tire. The raw rubber tape S can be produced by means of an extruder and calendar rollers for example. Here, the raw rubber means unvulcanized rubber as well as semi-vulcanized rubber.

AS shown in FIG. 5, the tape S has a substantially constant width w and a substantially constant thickness t. If the tape S is too small in the thickness and/or width, then the production efficiency is lowered and the tape becomes liable to break during winding. Therefore, the thickness t is preferably set in a range of not less than 0.8 mm, more preferably not less than 1.0 mm, and the width w is preferably set in a range of not less than 5 mm, more preferably not less than 10 mm.

If the tape S is too large, then it becomes difficult to winding the tape into the desired target cross-sectional shape. Therefore, the thickness t is preferably set in a range of not more than 3.0 mm, more preferably not more than 2.5 mm, and the width w is preferably set in a range of not more than 40 mm, more preferably not more than 30 mm.

The tread rubber G1 can be formed by winding more than two rubber tapes S, regardless of whether these are the same rubber compound or different compounds.

In the example shown in FIG. 4, the tread rubber G1 is formed by winding two rubber tapes Sa and Sb made form the same rubber compound, using two tape applicators (not shown).

The first rubber tape Sa is overlap-wound, starting from one side A, towards the other side B, and the overlap-winding terminates in the middle of the width of the tread rubber G1 so as to form about one half of the tread rubber G1. Thus, the first rubber tape Sa has a wind-starting end e1 at the one side A and a wind-ending end e2 (not shown in FIG. 4) in the middle of the tread rubber width.

The second rubber tape Sb is overlap-wound, starting from the other side B, towards the one side A, and the overlap-winding terminates in the middle of the width of the tread rubber G1 so as to form the remaining part (about one half) of the tread rubber G1. Thus, the second rubber tape Sb has a wind-starting end e1 at the other side B and a wind-ending end e2 (shown in FIG. 4) in the middle of the width of the tread rubber.

The wind-ending ends e2 of the tapes Sa and Sb appear in the outer surface of the tread rubber G1, namely, a mass of the windings of the tapes Sa and Sb.

The wind-starting ends e1 of the tapes Sa and Sb exist below the tread rubber G1, adjoining the tread reinforcing belt 7.

In this embodiment, in order to simultaneously wind the first rubber tape Sa and second rubber tape Sb around the round body u, the tape applying positions in the circumferential direction by the two applicators are set at circumferentially different positions, for example which differs 180 degrees, to avoid mutual interference of the applicators.

Thus, the wind-ending end e2 of the first rubber tape Sa is located at a circumferentially different position than that of the wind-ending end e2 of the second rubber tape Sb, which differs 180 degrees in this example. Same can apply to the wind-starting ends e1.

The above-mentioned mold 12 in this embodiment is a segmental mold comprising: a tread sectors 12c, a lower side plate 12a, an upper side plate 12b, and a pair of bead rings 12d. In the closed state of the mold 12, the lower side plate 12a, upper side plate 12b, tread sectors 12c and bead rings 12d form a hollow 16 into which the green tire 1M is put, and the inner surfaces thereof collectively define the molding surface 13 for molding the outer surface of the tire.

The lower side plate 12a has a surface for molding the outer surface of one of the sidewall portions of the green tire 1M. The upper side plate 12b has a surface for molding the outer surface of the other sidewall portion of the green tire 1M. The bead rings 12d each have a surface for molding the axially outer surface and bottom surface of the bead portion 4. The tread sectors 12c have inner surfaces collectively defining a surface for molding the outer surface of the tread portion 2. The upper side plate 12b is supported movably toward and away from the lower side plate 12a. The tread sectors 12c are supported movably in the radial direction of the green tire 1M toward and away from the side plate 12a and 12b.

In any configuration, the surface for molding the outer surface of the tread portion 2 is provided with protrusions 14 for molding the tread grooves 10.

The protrusions 14 have the same shapes as those of the tread grooves 10, and accordingly include: circumferentially extending protrusions 14a for molding the circumferential grooves 8; and axially extending protrusions 14b for molding the axial grooves 9.

According to the present invention, it is necessary that, during vulcanizing the green tire 1M, the end e2 of the rubber tape S appearing on the outer surface of the tread rubber, which is usually the wind-ending end, is pressed down by one of the protrusions 14.

As to the other end e1 hidden bellow or between the windings, which is usually the wind-starting end, it is also preferable that the end e1 is pressed by one of the protrusions 14.

In FIG. 6(a) showing the tread rubber G1 of the green tire 1M not put in the mold, the wind-ending end e2 of the rubber tape Sa, Sb forms a step on the outer surface of the tread rubber G1. The same position of the green tire as FIG. 6(a) during vulcanization is shown in FIG. 6(b).

In the process of vulcanizing the tire, the tread rubber is pressed onto the tread molding surface of the mold as explained above, and accordingly, the step formed by the end e2 is pressed down by the protrusion and disappeared. Therefore, it is possible to avoid the end e2 remained visible on the surface of the finished tire like a scratch or cut, and also the uniformity of the finished tire can be improved.

In FIG. 7(a) showing the tread rubber G1 of the green tire 1M not put in the mold, the wind-starting end e1 of the rubber tape Sa, Sb forms a small cavity filled with air. The same position of the green tire as FIG. 7(a) during vulcanization is shown in FIG. 7(b). In the process of vulcanizing the tire, the tread rubber is pressed onto the tread molding surface of the mold, and accordingly, the air entrapped at the end e1 is pushed out toward vent holes (not shown) of the mold 12. As a result, mold defectiveness such as bareness of rubber and dent resulting from the remained air can be effectively prevented.

As has been explained, according to the present invention, when putting the green tire in the mold, it is necessary to match the positions of the ends e1, e2 with the positions of the selected protrusions 14.

In the case of the end e2 appearing on the outer surface, it is easy to locate the end e2. However, in the case of the hidden end e1, it is difficult to locate from the outside of the green tire. Therefore, in the process of winding the raw rubber tape S into the tread rubber G1, marking of the position of the end e1 is preferably made on the outer surface of the completed tread rubber G1 so as to utilize the mark when matching the positions.

As known from the above, the matching of the tape end position with the position of a circumferentially extending protrusion 14a (circumferential groove 8) is much easier than the axially extending protrusion 14b (axial groove 9). Therefore, in the case of the tread pattern shown in FIG. 8, the axial position of the wind-ending end e2 is matched with the axial position of the protrusion 14a for molding the central circumferential groove 8a. But, in the case of the wind-starting end e1, since there is no circumferential groove near the end e1, the protrusion 14b for molding one of the axial grooves 9b is utilized instead.

In this way, the end (e1, e2) can be aligned with either the circumferentially extending protrusion 14a (circumferential groove) or the axially extending protrusion 14b (axial groove).

In the case that the axially extending protrusion 14b (axial groove 9) is utilized, as shown in FIG. 9, it is possible to cut the rubber tape end e1 or e2 at the same angle as the inclination angle of the axial groove 9 so that the end (at least 50%, preferably 100% thereof) is located within the width of the axial groove 9.

In order to effectively press the end (e1, e2) without cutting the end of the rubber tape, the width of the protrusion 14 (accordingly the width GW of the resultant groove) is preferably not less than 3 mm. In other words, it is preferred that the end (e1, e2) is placed radially inside a protrusion 14 having such a width GW of not less than 3 mm.

Further, it is preferable that at least 30%, more preferably more than 50% in width of the end (e1, e2) is pressed down by the protrusion 14. Namely, at least 30% preferably more than 50% of the width of the end is overlapped with the protrusion 14 when the green tire is put in the mold.

Furthermore, in the case of the end e2 appearing on the outer surface, it is desirable that the entirety of the end e2 lies within the surface of the groove of the finished tire, more preferably within the bottom surface of the groove. For that purpose, at least 50% of the width of the end e2 is positioned within the width GW of the protrusion 14 especially protrusion 14a.

### Comparison Tests

Pneumatic tires of size 215/45ZR17 for passenger cars having the same structures except for the specifications shown in Table 1 were experimentally manufactured. With respect to each tire, 100 specimens were produced and checked for the finished state of the tread rubber and the tire uniformity.

Finished State Test:

The surface of the tread rubber was visually inspected as to whether the defect like a scratch or cut due to the wind-ending end was occurred or not, and the number of the specimen tires on which such defect was occurred was counted to obtain the rate of occurrence. The results are shown in Table 1.

Tire Uniformity Test:

The radial force variation RFV (overall) at a speed of 10 km/h was measured according to JASO C607:2000 “Test method for automobile tire uniformity”. The results are shown in Table 1, wherein the smaller the value, the better the uniformity.

From the test results, it was confirmed that, in comparison with the Ref. tires, the Example tires are excel in both of the finished state of the tread rubber and the tire uniformity.

TABLE 1

| Tire | Ref. 1 | Ref. 2 | Ref. 3 | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|---|
| Rubber tape | | | | | | | | | | | | |
| Width SW (mm) | 25 | 25 | 25 | 25 | 25 | 25 | 25 | 25 | 25 | 25 | 25 | 25 |
| Thickness t (mm) | 2 | 1 | 3 | 1 | 1 | 2 | 3 | 1 | 1 | 1 | 2 | 3 |
| Overlap of Wind-ending end | 0 | 0 | 0 | 40 | 100 | 100 | 100 | 60 | 80 | 100 | 100 | 100 |
| with Protrusion (%) | | | | | | | | | | | | |
| Overlap of Wind-starting end | 0 | 0 | 0 | 0 | 0 | 0 | 0 | 0 | 0 | 100 | 100 | 100 |
| with Protrusion (%) | | | | | | | | | | | | |
| Test results | | | | | | | | | | | | |
| Occurrence of defect (%) | 1.2 | 0.6 | 1.7 | 0.7 | 0 | 0 | 0 | 0.2 | 0.1 | 0 | 0 | 0 |
| Uniformity RFV (N) | 57 | 53 | 61 | 58 | 44 | 46 | 49 | 53 | 50 | 41 | 42 | 45 |

1. A method for manufacturing a pneumatic tire with tread grooves comprising:
building a green tire, wherein the building of the green tire includes making a tread rubber by overlap-winding a raw rubber tape, and
vulcanizing the green tire in a mold, wherein the mold is provided with protrusions for molding the tread grooves on the tread rubber,
characterized by
placing one of said protrusions radially outside an end of the raw rubber tape wound as the tread rubber of the green tire in the mold, whereby
during vulcanizing the green tire in the mold, said end is relatively pressed radially inwards of the tire by said one of said protrusions.

2. The method according to claim 1, wherein
one of the protrusions is placed radially outside another end of said raw rubber tape so that said another end is relatively pressed radially inwards of the tire.

3. The method according to claim 1, wherein
said one of the protrusions has a width of at least 3 mm.

4. The method according to claim 1, wherein
at least 50% of the width of said end is overlapped with said one of the protrusions.

5. The method according to claim 1, wherein
the making of the tread rubber is by overlap-winding a plurality of raw rubber tapes including said first raw rubber tape and an additional second raw rubber tape, and
one of the protrusions is positioned radially outside an end of the additional second raw rubber tape so that, during vulcanizing the green tire in the mold, the end is relatively pressed radially inwards of the tire by said one of said protrusions.

6. The method according to claim 5, wherein
said protrusion placed radially outside the end of the second raw rubber tape is the same as said protrusion placed radially outside the end of the first raw rubber tape.

7. The method according to claim 5, wherein
said protrusion placed radially outside the end of the second raw rubber tape is different from said protrusion placed radially outside the end of the first raw rubber tape.

8. The method according to claim 1, wherein
said protrusion placed radially outside the end of the raw rubber tape is a circumferentially extending protrusion for molding one circumferential tread groove of said tread grooves.

9. The method according to claim 5, wherein
said protrusion placed radially outside the end of the first raw rubber tape and
said protrusion placed radially outside the end of the second raw rubber tape are one circumferentially extending protrusion for molding one circumferential tread groove of said tread grooves.

10. The method according to claim 5, wherein
said protrusion placed radially outside the end of the first raw rubber tape and
said protrusion placed radially outside the end of the second raw rubber tape are two circumferentially extending protrusions for molding two circumferential tread grooves of said tread grooves.

11. The method according to claim 1, wherein
said one of the protrusions positioned radially outside the end of the raw rubber tape is an axially extending protrusion for molding one axial tread groove of said tread grooves.

12. The method according to claim 5, wherein
said protrusion placed radially outside the end of the first raw rubber tape and
said protrusion placed radially outside the end of the second raw rubber tape are one axially extending protrusion for molding one axial tread groove of said tread grooves.

13. The method according to claim 5, wherein
said protrusion placed radially outside the end of the first raw rubber tape and
said protrusion placed radially outside the end of the second raw rubber tape are two axially extending protrusions for molding two axial tread grooves of said tread grooves.

14. The method according to claim 5, wherein
said protrusion placed radially outside the end of the first raw rubber tape and
said protrusion placed radially outside the end of the second raw rubber tape are one circumferentially extending protrusion for molding one circumferential tread groove of said tread grooves and
one axially extending protrusion for molding one axial tread groove of said tread grooves.

15. A pneumatic tire manufactured by the method according to claim 1, whereby at least 50% of the end is included within one of the tread grooves.

16. A pneumatic tire manufactured by the method according to claim 2, whereby at least 50% of the end is included within one of the tread grooves.

17. A pneumatic tire manufactured by the method according to claim 3, whereby at least 50% of the end is included within one of the tread grooves.

18. A pneumatic tire manufactured by the method according to claim 4, whereby at least 50% of the end is included within one of the tread grooves.

19. A pneumatic tire manufactured by the method according to claim 5, whereby at least 50% of the end is included within one of the tread grooves.

20. A pneumatic tire manufactured by the method according to claim 6, whereby at least 50% of the end is included within one of the tread grooves.
